(19) United States
(12) Patent Application Publication
(10) Pub. No.: US 2011/0148735 A1
(43) Pub. Date: Jun. 23, 2011

(54) DUAL-BAND ANTENNA

(75) Inventors: CHIH-YUAN YANG, Tu-Cheng (TW); CHIEN-TANG LIN, Tu-Cheng (TW); MING-LIANG YANG, Tu-Cheng (TW)

(73) Assignee: HON HAI PRECISION INDUSTRY CO., LTD., Tu-Cheng (TW)

(21) Appl. No.: 12/873,207

(22) Filed: Aug. 31, 2010

(30) Foreign Application Priority Data
Dec. 22, 2009 (CN) 200910312008.0

(51) Int. Cl. H01Q 21/28

(52) U.S. Cl. 343/893

(57) ABSTRACT

A dual-band antenna includes a RF connector, a radiation element, and a ground surface. The RF connector is connected to a RF receiver. The radiation element includes a first radiation element and a second radiation element. The first radiation element and the second radiation element are both connected to the RF connector. The RF connector is connected to the ground surface.

### BACKGROUND

1. Technical Field

The present disclosure relates to a dual-band antenna.

2. Description of Related Art

A Planar Inverted F Antenna (PIFA) is a commonly used antenna in radio communication devices. However, because the Planar Inverted F Antenna requires a large clearance area, it cannot satisfy the request for miniaturization of the radio communication devices. Further, with the development of wireless technology, a wide-band antenna is needed.

### BRIEF DESCRIPTION OF THE DRAWINGS

The components of the drawings are not necessarily drawn to scale, the emphasis instead being placed upon clearly illustrating the principles of the dual-band antenna. Moreover, in the drawings, like reference numerals designate corresponding parts throughout several views.

FIG. 1 is a schematic view of a dual-band antenna in accordance with an exemplary embodiment.

FIG. 2 is an electrical characteristics diagram of the antenna of FIG. 1.

### DETAILED DESCRIPTION

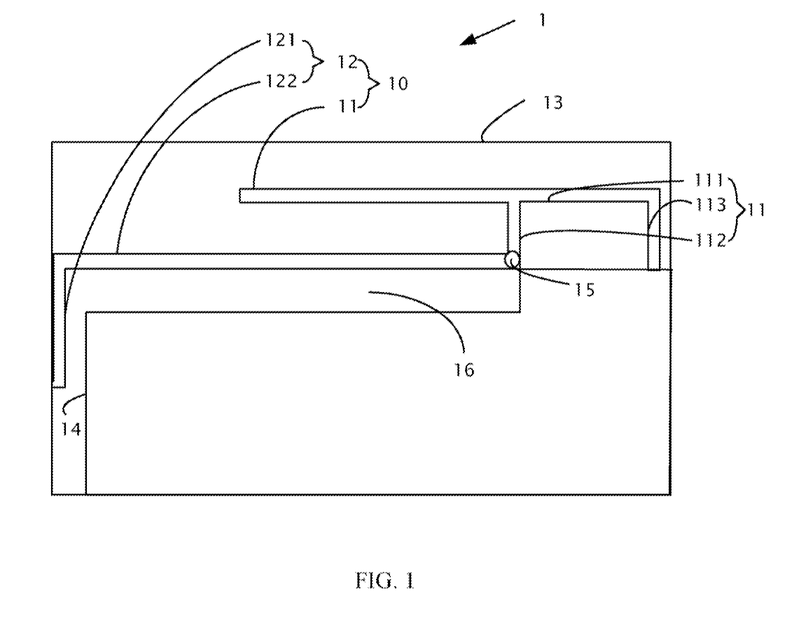

FIG. 1 is a schematic view of a dual-band antenna 1 in accordance with an exemplary embodiment. The antenna 1 is used for receiving radio frequency (RF) signals and radiating corresponding radio waves. The antenna 1 includes a radiation element 10, a dielectric element 13, a ground surface 14, and a RF connector 15. The radiation element 10, the ground surface 14, and the connector 15 are supported by the dielectric element 13. The radiation element 10 and the ground surface 14 are conductive. The RF connector 15 is connected to a RF receiver (not shown) to receive RF signals.

The radiation element 10 includes a first radiation element 11 and a second radiation element 12. In this embodiment, the first radiation element 11 is a PIFA antenna. The second radiation element 12 is a folded antenna. The first radiation element 11 and the second radiation element 12 are both connected to the RF connector 15. The RF connector 15 is connected to the ground surface 14. The first radiation element 11 includes a first radiation body 111, a first RF lead 112, and a ground connector 113. One end of the first RF lead 112 and the ground connector 113 are both perpendicularly connected to the first radiation body 111. The other end of the first RF lead 112 is connected to the RF connector 15. The other end of the ground connector 113 is connected to the ground surface 14.

The second radiation element 12 is substantially L shaped and includes a second RF lead 121 and a second radiation body 122. One end of the second RF lead 121 is perpendicularly connected to the second radiation body 122. The other end of the second RF lead 121 is connected to the RF connector 15. The second radiation element 12 is spaced from the ground surface 14. The space 16 between the second radiation element 12 and the ground surface 14 provides a clearance area to the first radiation element 11 and the second radiation element 12, thus miniaturization of the antenna 1 can be accomplished. Further, each of the first radiation element 11 and the second radiation element 12 can provide one frequency, thus the dual-band antenna is accomplished.

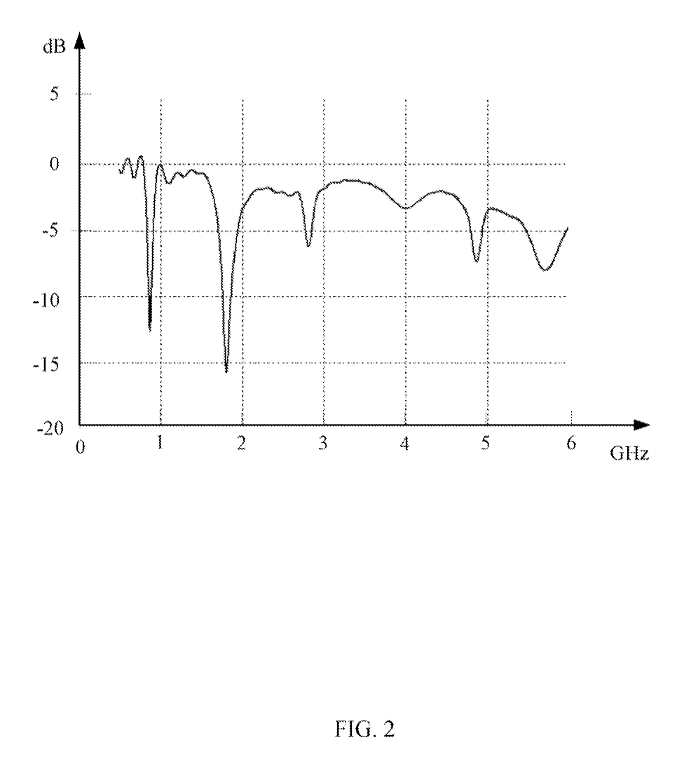

FIG. 2 is an electrical characteristics diagram of the antenna 1 to show return losses of the antenna 1 at different frequencies. It can be seen from the diagram when the frequency of the antenna is 0.9 GHz, the return loss of the antenna is −13 dB, and when the frequency of the antenna is 1.8 GHz, the return loss of the antenna is −16 dB. The return loss corresponding to 0.9 GHz and 1.8 GHz is far below the return loss at other frequencies. Thus, it is established that the antenna 1 can be an effective dual-band antenna.

Although the present disclosure has been specifically described on the basis of preferred embodiments, the disclosure is not to be construed as being limited thereto. Various changes or modifications may be made to the embodiment without departing from the scope and spirit of the disclosure.

What is claimed is:

1. A dual-band antenna, comprising:
a RF connector being connected to a RF receiver;
a radiation element, comprising:
a first radiation element and a second radiation element, the first radiation element and the second radiation element being both connected to the RF connector; and
a ground surface connected to the RF connector.

2. The dual-band antenna as described in claim 1, wherein the first radiation element is a Planner Inverted F Antenna (PIFA).

3. The dual-band antenna as described in claim 2, wherein the first radiation element comprises a first radiation body, a first RF lead, and a ground connector, one end of the first RF lead and the ground connector are both perpendicularly connected to the first radiation body, the other end of the first RF lead is connected to the RF connector, the other end of the ground connector is connected to the ground surface.

4. The dual-band antenna as described in claim 1, wherein the second radiation element is a folded antenna and substantially L shaped.

5. The dual-band antenna as described in claim 4, wherein the second radiation element comprises a second RF lead and a second radiation body, one end of the second RF lead is perpendicularly connected to the second radiation body, the other end of the second RF lead is connected to the RF connector.

6. The dual-band antenna as described in claim 4, wherein the second radiation element is spaced from the ground surface.
